(19) United States
(12) Patent Application Publication
(10) Pub. No.: US 2006/0097473 A1
(43) Pub. Date: May 11, 2006

(54) Easy roll wheel adapter

(76) Inventor: Robert Victor DeFrance, Poughkeepsie, NY (US)

Correspondence Address: FROMMER LAWRENCE & HAUG, 745 FIFTH AVENUE- 10TH FL., NEW YORK, NY, 10151, US

(21) Appl. No.: 11/150,359

(22) Filed: Jun. 10, 2005

Related U.S. Application Data
(60) Provisional application No. 60/625,088, filed on Nov. 5, 2004.

(51) Int. Cl. B62M 1/14

(52) U.S. Cl. 280/244

(57) ABSTRACT

A wheelchair mobility apparatus for use on one or more push wheels of a wheelchair that includes a substantially fork shaped member that straddles the one or more push wheels, the member having a first portion, a second portion and an intermediate portion disposed between the first portion and the second portion. The first portion pivotally mounts the member to the wheelchair and the second portion extends above an armrest of the wheelchair.

### CROSS-REFERENCE TO RELATED APPLICATIONS

This application is based upon and claims the benefit of U.S. Provisional Patent Application Ser. No. 60/625,088 filed Nov. 5, 2004 entitled “EASY ROLL WHEEL ADAPTER”, the disclosure of which is incorporated herein by reference.

### BACKGROUND OF THE INVENTION

1. Field of the Invention

The present invention relates generally to wheelchairs, and more particularly to an improved means for propelling a wheelchair.

2. Background of the Invention

The wheelchair is a device that enables disabled persons to achieve independence by allowing the individual to freely maneuver themselves throughout accessible destinations. The wheelchair consists of two large wheels in the rear of the seat known as “Push Wheels,” and two smaller wheels in the front of the seat, known as “Casters.” The push wheels are fixed relative to the frame of the wheelchair. The casters are able to pivot 360-degrees allowing directional control of the wheelchair. The push wheels are located on either side of the seat at 180 degrees from each other. The center of the wheel is perpendicular with the back of the individual. The casters are located near the individuals' feet, one to the right of the right foot and the other to the left of the left foot.

The push wheels have a ring attached to the outer part of each wheel. This ring is known as the “Hand Rim” and is slightly smaller in diameter than the push wheel. The hand rim is secured to the push wheels by a series of screws thus allowing the two to move simultaneously when force is applied to the hand rim by the user. The hand rim is offset from the push wheel by tubular spacers (standoffs) to provide clearance of approximately ¾-inch so that it can be gripped without interfering with the push wheel. The function of the hand rim is to allow the user to grip it with his or her hands and apply a force to rotate the push wheel in the desired direction to move the wheelchair either forwards or backwards. The hand rims are located so that the user can easily reach them with their hands while situated in a comfortable seated position. The user can maneuver the direction of the wheelchair by applying additional force and hence rotation to either the left or right hand rim.

The majority of hand-propelled wheelchairs in present use are equipped with these tubular steel hand rims. The cross sectional contour of the hand rim is circular of approximately ⅝-inch diameter. While generally suitable for their intended purpose of propelling and maneuvering the wheelchair, the standard hand rim has numerous disadvantages.

The relatively small diameter (⅝ of an inch) of the hand rim tubing section provides only a limited gripping surface for the user. Thus, when the user attempts to propel the chair in difficult situations, as when going up ramps, traveling on soft carpets, or traversing rough terrain, he or she often experiences difficulty and must resort to such tactics as placing his or her hands over both the tire and hand rim to exert sufficient torque. The limited surface area of the standard hand rim also limits the ability of the user to properly and safely control and brake the wheelchair while descending a ramp. Due to the hand rim's lack of surface area, the user often finds it necessary to wrap his or her fingers around most of the tube diameter to get a sufficient grip, and thus tends to get his or her fingers caught up on the standoffs. This problem is particularly acute when the user is descending a ramp.

Even assuming that the user is able to satisfactorily propel and control the wheelchair, and it can probably be assumed that this is the case much of the time, it is clear that mobility can be improved inasmuch as the conventional hand rim does not fit the user's hand in a comfortable manner, especially when extra torque or gripping action must be applied. Thus, a considerable amount of the user's effort is expended in gripping the hand rim rather than in applying torque to propel the wheelchair.

If the user of the wheelchair has restricted or little or no use of his or her hands, however, the conventional push rim does not provide a satisfactory means of providing a force sufficient to propel the wheelchair, even though such a person may be able to use his arms and/or his shoulder muscles. On many wheel chairs the hand rims do carry short push rods to help the user propel the wheel chair. These rods, however, are short and not optimally positioned.

Various other different propelling mechanisms have been devised to provide users of wheelchairs who have little or no use of their hands but do have use of their arm and/or shoulder muscles with a means to propel their wheel chairs.

On the market, there are some lightweight wheelchairs that are equipped with integral hand rim and wheel rim assemblies. For example, U.S. Pat. No. 2,938,738 discloses a combined hand rim and wheel rim for a wheelchair that is preferably formed from a single extruded section. The hand rim has a non-circular cross-sectional contour. This construction provides a continuous web between the wheel rim and the hand rim, thus avoiding the problem wherein the user's fingers get caught up in the stand offs. This configuration, however, has the disadvantage that it limits the user's gripping capability since the user's fingers cannot fully encircle the hand rim.

A different set of problems is presented for those users with partial quadriplegia and thus limited grip strength. A typical prior art hand rim for such users utilizes a circular ring, similar to a regular hand rim, having a plurality of radially or axially projecting handles or push rods that the user may push with his or her palm without having to grip the hand rims. These so-called “projection” hand rims are useful when required, but are heavy and relatively expensive. Moreover, they are extremely awkward and unsuitable for general use. The main problem is that the push rods easily become caught up on draperies, furniture, and the like. U.S. Pat. No. 4,039,199 discloses a system wherein the push rods are partially retracted towards the bottom of their travel, thus at least partially obviating this problem. This result, however, is achieved at the expense of the system's complexity.

Accordingly, a need exists for an improved means for propelling a wheelchair.

### SUMMARY OF THE INVENTION

It is an object of the present invention to provide an improved means for propelling a wheelchair that requires less effort on the users part.

It is a further object of the present invention to provide a wheelchair propelling means that utilizes a cantilever action instead of the traditional gripping and rotation of a wheelchair's push wheels.

One embodiment of the present invention is directed to a wheelchair mobility apparatus for use on one or more push wheels of a wheelchair. The mobility apparatus comprises a substantially fork shaped member that straddles the one or more push wheels of a wheelchair. The substantially fork shaped member has a first portion, a second portion and an intermediate portion disposed between the first and second portions. The first portion of the substantially fork shaped member pivotally mounts the member to the wheelchair and the second portion of the member extends above the armrests of the wheelchair.

In addition, the wheelchair mobility apparatus also includes a means for fixing the substantially fork shaped member in relation to the one or more push wheels of the wheelchair. When the substantially fork shaped member is fixed relative to the one or more push wheels, a user can impart motion to the wheelchair by pulling or pushing the second portion of the substantially fork shaped member. Furthermore, the mobility apparatus includes a means for actuating the fixing means.

Another embodiment of the present invention is directed to a method for propelling a wheelchair. The method comprises the steps of positioning a braking member relative to one or more push wheels of a wheelchair. Once positioned, the braking member is locked into a fixed position relative to the one or more push wheels. After being locked, the braking member is displaced frontward or rearward in order to rotate the one or more push wheels and propel the wheelchair in a desired direction. The steps are repeated for the desired distance that a user wants to travel.

The various features of novelty that characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1A is a right elevation view of a conventional wheelchair with the mobility apparatus of the present invention installed and positioned toward the rear of a guide slot;

FIG. 1B is a front elevation view of a conventional wheelchair with the mobility apparatus of the present invention installed and positioned toward the rear of a guide slot;

FIG. 1C is a left elevation view of a conventional wheelchair with the mobility apparatus of the present invention installed and positioned toward the rear of a guide slot;

FIG. 2A is a right elevation view of a conventional wheelchair with the mobility apparatus of the present invention installed and positioned toward the front of a guide slot;

FIG. 2B is a rear elevation view of a conventional wheelchair with the mobility apparatus of the present invention installed and positioned toward the rear of a guide slot;

FIG. 2C is a left elevation view of a conventional wheelchair with the mobility apparatus of the present invention installed and positioned toward the front of a guide slot;

FIG. 3A is a left elevation view of a conventional wheelchair with the mobility apparatus of the present invention installed and positioned toward the rear of a guide slot;

FIG. 3B is a rear elevation view of a conventional wheelchair with the mobility apparatus of the present invention installed and positioned toward the rear of a guide slot;

FIG. 3C is a right elevation view of a conventional wheelchair with the mobility apparatus of the present invention installed and positioned toward the rear of a guide slot;

FIG. 4A is a left elevation view of a conventional wheelchair with the mobility apparatus of the present invention installed and positioned toward the front of a guide slot;

FIG. 4B is a rear elevation view of a conventional wheelchair with the mobility apparatus of the present invention installed and positioned toward the rear of a guide slot;

FIG. 4C is a right elevation view of a conventional wheelchair with the mobility apparatus of the present invention installed and positioned toward the front of a guide slot;

FIG. 5A is a front view of a two-legged drive arm bracket with the driver assembly and the drive lever control assembly installed, according one embodiment of the present invention;

FIG. 5B is a side view of a two-legged drive arm bracket with the driver assembly and the drive lever control assembly installed, according one embodiment of the present invention;

FIG. 6A is a front view of a drive arm bracket having one full leg and one leg portion, according to one embodiment of the present invention;

FIG. 6B is a front view of a drive arm bracket having two full legs, according to one embodiment of the present invention;

FIG. 7 is a rear view of the driver assembly, according to one embodiment of the present invention;

FIG. 8A is a rear view of the mobility device of the present invention with the driver assembly actuated and the drive pads in contact with a push wheel rim, according to one embodiment of the present invention;

FIG. 8B is a front view of the mobility device of the present invention with a non-actuated driver assembly and the drive pads not in contact with a push wheel rim, according to one embodiment of the present invention;

FIG. 9A is a side view of a drive lever control assembly, according to one embodiment of the present invention;

FIG. 9B is front view of a drive lever control assembly, according to one embodiment of the present invention;

FIGS. 10A and 10B are side views of the drive lever control assembly with a locking brake assembly installed, according to one embodiment of the present invention;

FIG. 11A is a top view of a locking brake assembly, according to one embodiment of the present invention;

FIG. 11B is a side view of a locking brake assembly, according to one embodiment of the present invention;

FIG. 12 is a top view of a conventional wheelchair with the mobility apparatus of the present invention installed; and

FIG. 13 is a cable retaining means, according to one embodiment of the present invention.

### DETAILED DESCRIPTION OF THE PREFERRED EMBODIMENTS

The main objective of the present invention is to provide a feasible alternative to the use of the hand rim propulsion design in the form of a device that can be attached to a wheelchair to create improved mobility. The simplicity of the design of the present invention is such that it can be very easily adapted to existing wheelchairs of both the foldable or rigid frame type regardless of brand or manufacturer. The present invention or mobility device enables a user to propel the wheelchair by means of a cantilever action as opposed to the traditional gripping and rotation of the hand rim. The “levers” of the mobility device provide the user with increased leverage, which equates to less force needed and thereby less strength needed to be applied by a user in order to rotate the push wheels and therefore propel the wheelchair. The present invention greatly reduces the amount of effort it takes to put a wheelchair in motion.

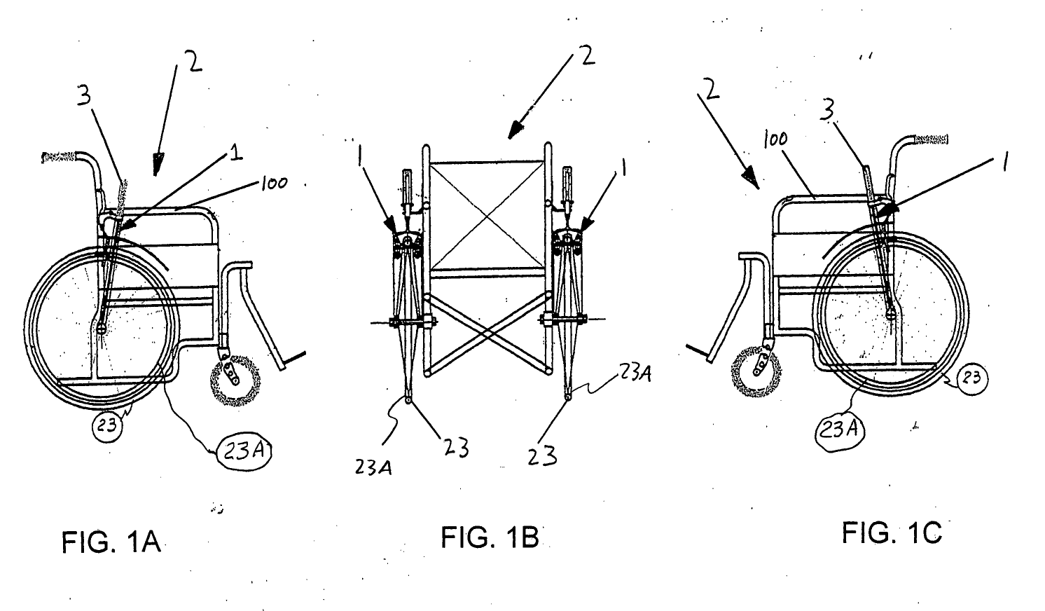

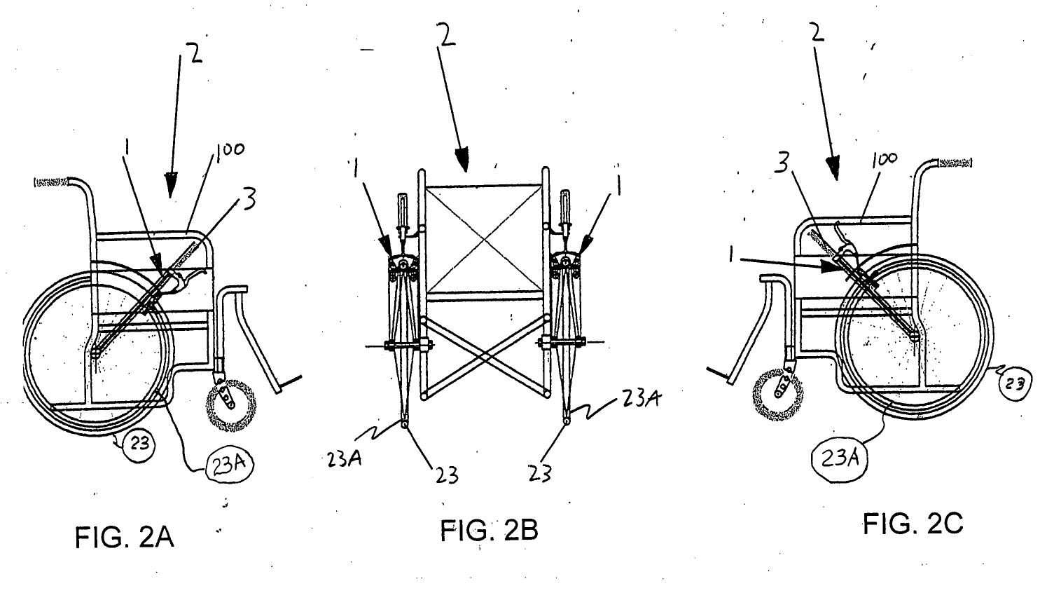

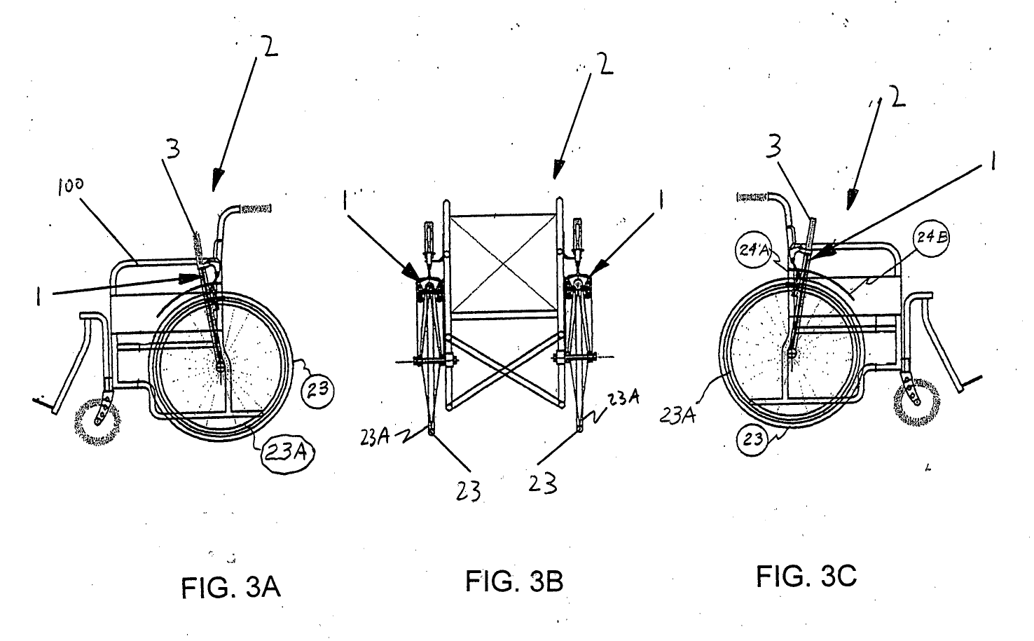

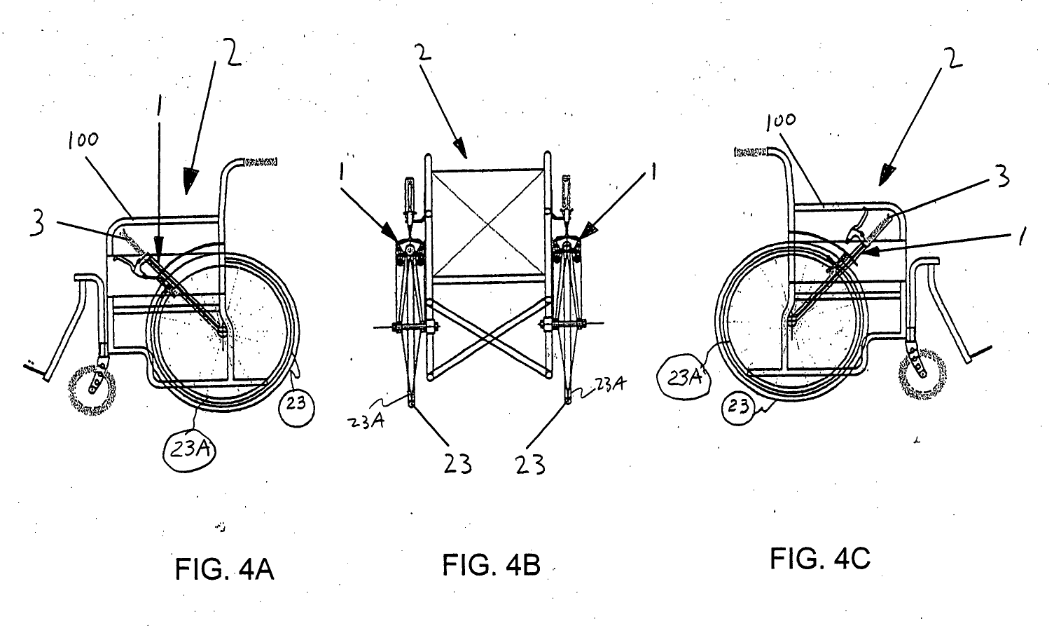

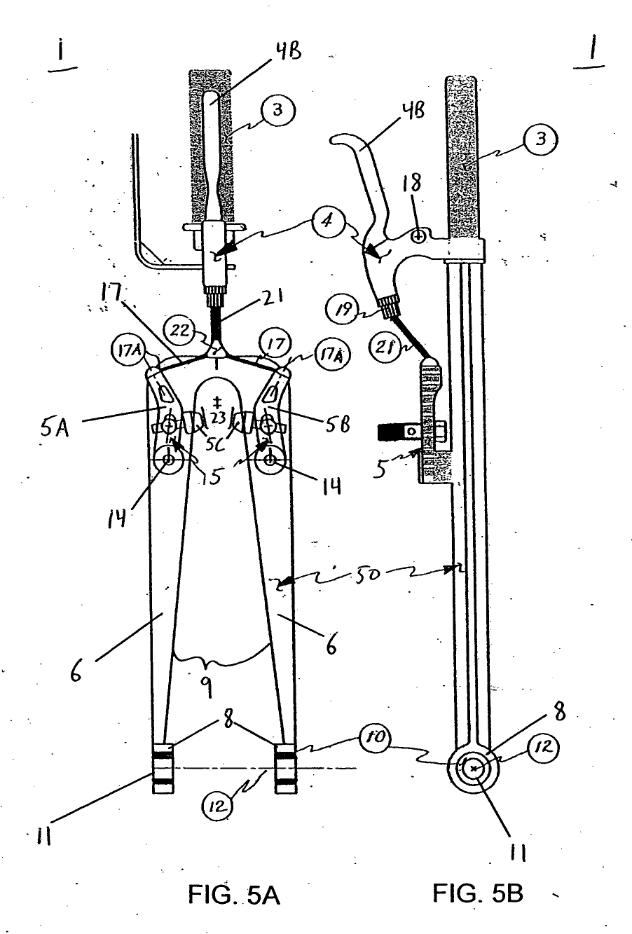

As depicted in FIGS. 1-4, the present invention or mobility device 1 attaches to a conventional wheelchair 2 of the foldable or rigid frame type. The mobility device 1 attaches to a wheelchair 2 on both the right and the left sides straddling (spanning) each push wheel 23. The mobility device 1 attaches to the sides of a wheelchair 2 such that the rubber handgrips 3 extend above the armrests 100, thus allowing for easier hand accessibility by the user. As depicted in FIGS. 5A and 5B, the mobility device 1 comprises a drive arm bracket 50, a rubber handgrip 3, a drive lever control assembly 4, and a driver assembly 5. The handgrip 3, drive lever control assembly 4 and driver assembly 5 are assembled on a drive arm bracket 50, which is essentially a lever member or structure having a wishbone or fork shaped 9 bottom portion.

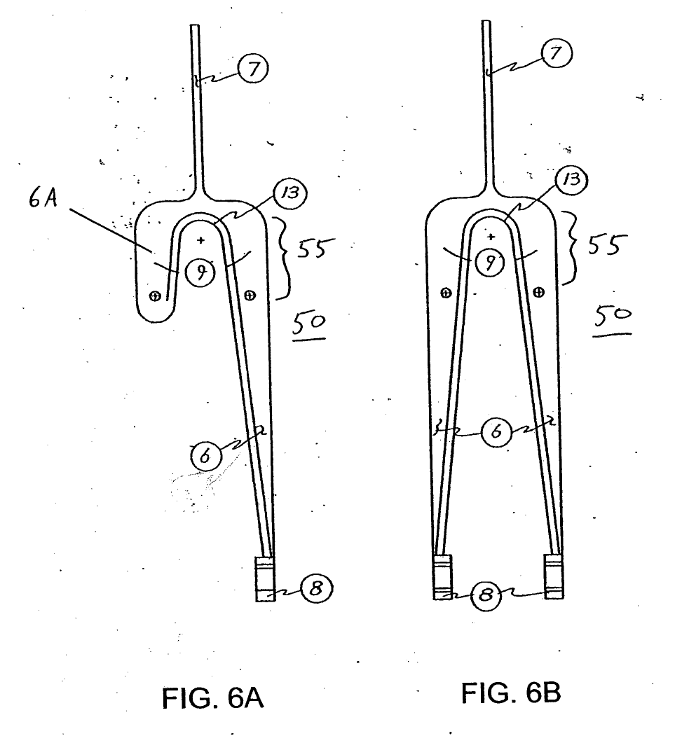

The drive arm bracket 50 is depicted in FIGS. 6A and 6B. In alternative embodiments, the drive arm bracket 50 may have one full leg 6 and one portion of a leg 6A (FIG. 6A) or two full legs 6 (FIG. 6B). As used herein, a full leg is defined as having a cylindrical barrel or some other attaching means at a bottom end (end opposite shank portion 7) and a leg portion is defined as being shorter than a full leg and not having a cylindrical barrel or other attaching means at a bottom end. The drive arm bracket 50 comprises a shank 7 portion, an intermediate or middle portion 55 and two full legs 6 or one full leg 6 and one leg portion 6A. At the lower end of each full leg 6 is included a cylindrical barrel 8. The cylindrical barrel(s) 8 is/are the mounting or connection point of the mobility device 1 to the wheelchair 2.

Referring again to FIGS. 5A and 5B, the cylindrical barrels 8 of the drive arm bracket 50 have a set of bearings 10 included within them. Since the cylindrical barrels 8 surround the pivoting point 12 of the drive arm bracket 50, the bearings 10 allow the bracket 50 to pivot more easily around the axle 11 of the push wheel 23 upon which the bracket 50 is installed. Installation of the drive arm bracket 50 will be discussed more clearly and in more detail below. At the intermediate portion of the drive arm bracket 50 where the shank 7 and the full legs 6 or leg portion 6A meet is formed a “U” intersection 13. Offset from the “U” intersection 13, below the shank 7 and towards the upper portion of the legs 6 and or leg portion 6A, is the intermediate or middle portion 55 of the drive arm bracket 50. At this intermediate portion 55 is mounted the driver assembly 5.

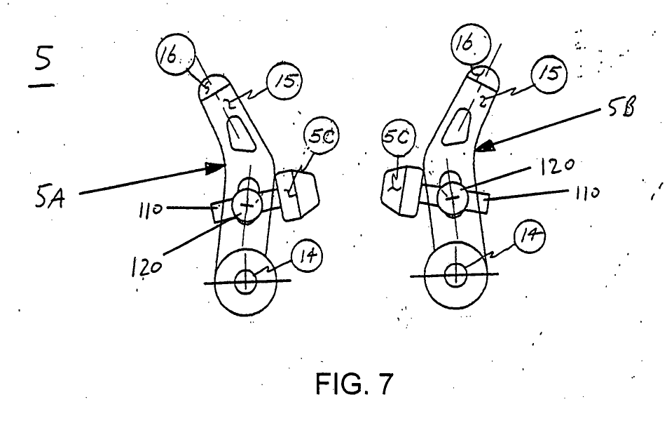

As depicted in FIG. 7, the driver assembly 5 comprises a right driver arm assembly 5A and a left driver arm assembly 5B. Each driver arm assembly, 5A and 5B, comprises a driver arm 15, a bearing assembly 14 at a bottom end for mounting to the full legs 6 or leg portion 6A of the drive arm bracket 50 and a cable retaining means 16 at an upper end for receiving and attaching a cable 17. The cable retaining means 145 can be, for example but not limited to, a nipple hole or slot 150 for receiving a nipple end of a cable (an end of a cable 155 having a barrel-shaped structure 160 attached as depicted in FIG. 13). The cable retaining means can also be a rod or bolt-like member having a flattened or head end and a threaded portion with a hole disposed between the two ends, perpendicular to the rod's cylindrical surface, for receiving a cable. When the rod-like member is placed through a hole in portion 16 of the driver arm 15, a cable is inserted into the hole in the shaft. A nut threaded on the threaded portion of the rod-like member is threaded down, clamping the cable in a fixed position against the driver arm 15. Additional cable retaining means will be readily apparent to one skilled in the art.

The driver arm assemblies, 5A and 5B, are mounted through the bearing assemblies 14 to the full legs 6 and/or leg portion 6A by any attaching means, such as but not limited to nuts and bolts. Other attaching means will be readily apparent to those skilled in the art. Mounted on each driver arm assembly, 5A and 5B, are drive pads 5C. The drive pads 5C can be mounted to the driver arm assemblies using any attaching means, such as but not limited to posts 110 and screws 120, allowing the drive pads 5C to be laterally adjustable, that is so they can be moved towards or away from the push wheel 23. Additional mounting means will be readily apparent to those skilled in the art. The driver pads, however, may also be fixedly attached to the driver arm assemblies, 5A and 5B. In addition, the driver assembly 5 also comprises a spring or other resilient member [NOT SHOWN ON DRAWINGS] that is attached to the driver arms 15 causing the driver arms 15 to retract from the push wheel 23 when force is removed from the assembly 5.

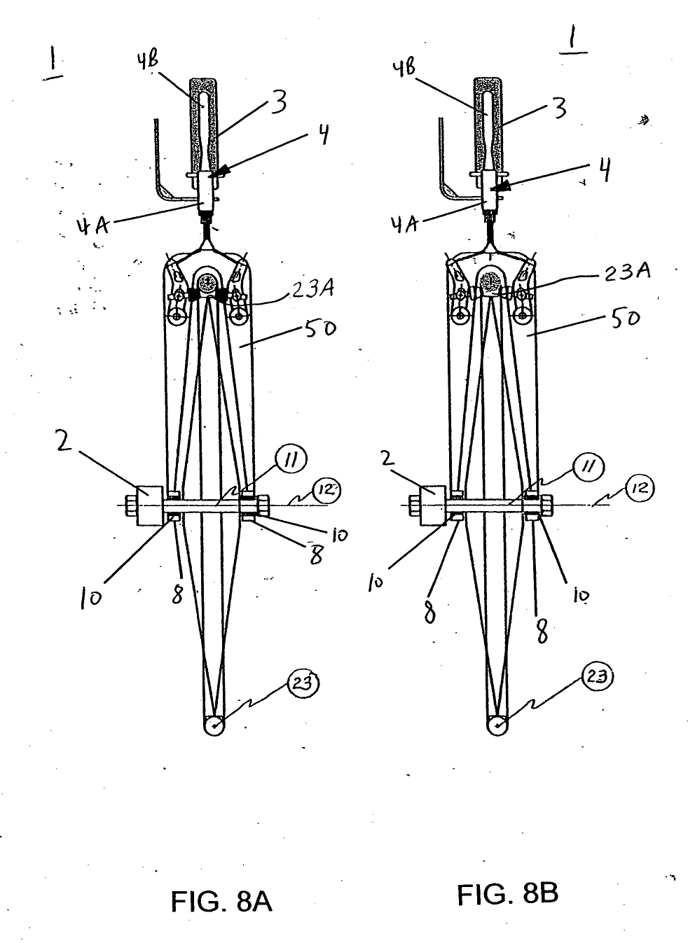

As depicted in FIGS. 8A and 8B, the drive arm bracket 50 attaches to the wheelchair 2 by way of the push wheel's axle 11. To attach the drive arm bracket 50, the axle 11 is first removed from the push wheel 23. The drive arm bracket 50 is then positioned over the push wheel 23 such that the bracket 50 straddles the push wheel 23 and the cylindrical barrel(s) 8 line up with the axle hole in the push wheel 23. Once in place, the axle 11 is inserted into the cylindrical barrels 8 and bearings 10 and through the axle hole in the push wheel 23 and the axle hole in the wheelchair so as to complete the installation. The installation procedure is the same regardless of whether the drive arm bracket 50 has two legs 6 or one full leg 6 and one leg portion 6A. If a drive arm bracket 50 having two full legs 6 is being attached to the wheelchair 2, an axle 11 of sufficient length to pass through the cylindrical barrels 8 on each leg 6 will be necessary. It is readily apparent that if a drive arm bracket 50 having one full leg 6 and one leg portion 6A is being attached, a shorter axle 11 may be used.

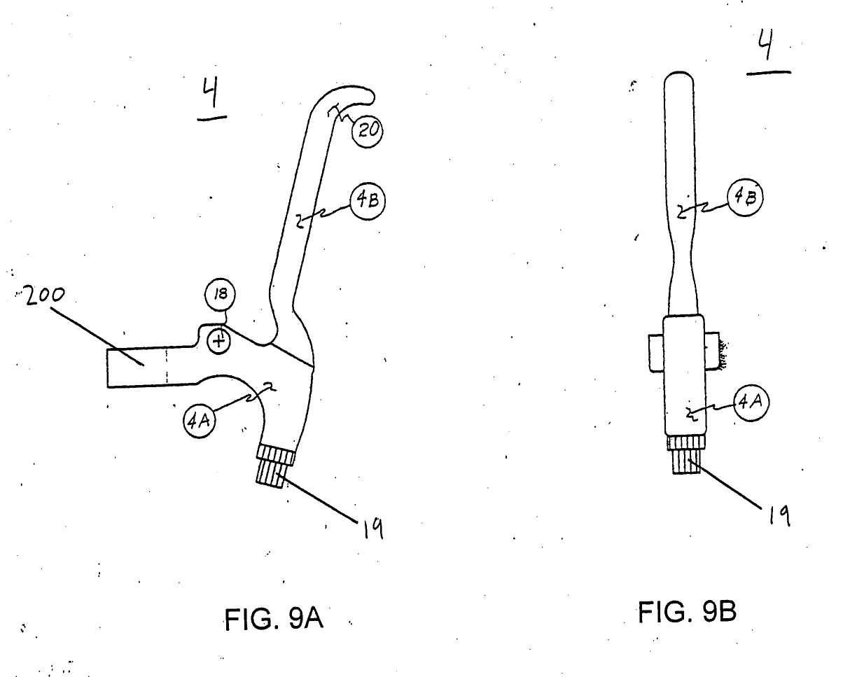

In one embodiment, the driver assembly 5 is actuated by a drive lever control assembly 4. As depicted in FIGS. 9A and 9B, the drive lever control assembly 4 comprises a body 4A, a lever arm 4B and an attaching member 200 for mounting to the drive arm bracket 50. The lever arm 4B is pivotally mounted to the body 4A on pivot point 18 of the body 4A. A cable guide or cable passageway 19 is also included on the body 4A at the lower end of the drive lever control assembly 4, which allows a cable 21 to pass internally through body 4A and attach to the cable retaining means 145 of lever arm 4B. At the upper end of the drive lever control assembly 4 is the lever arm 4B that is in the shape of a hand lever 20 or any similar shape that can be grasped by a user's hand. At the lower portion of the lever arm 4B (the portion in contact with the body 4A) is included a cable retainer or cable restraining means 145 in which can be inserted an end of a cable 155 having a nipple or barrel connector 160 as previously described and depicted in FIG. 13. Additional cable retaining means will be readily apparent to one skilled in the art.

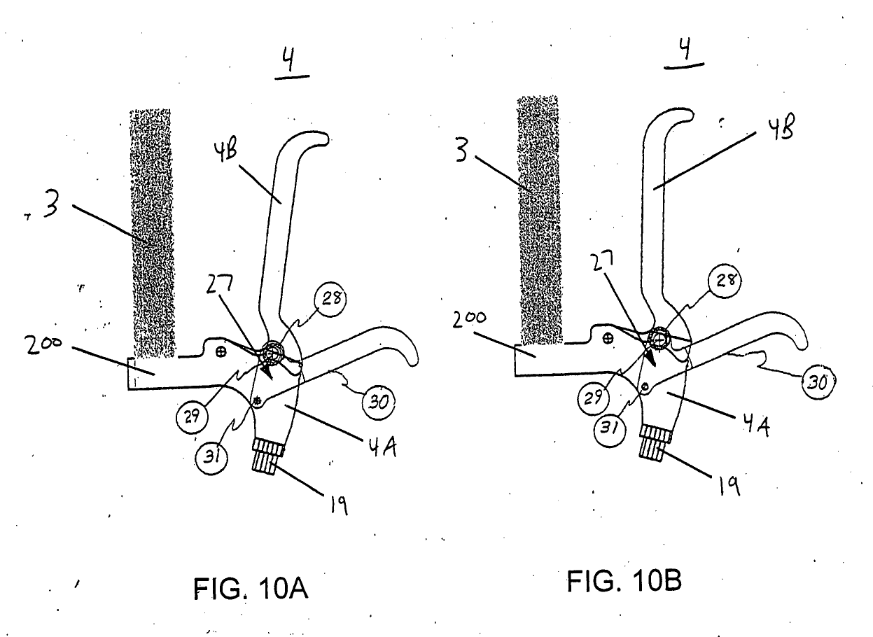

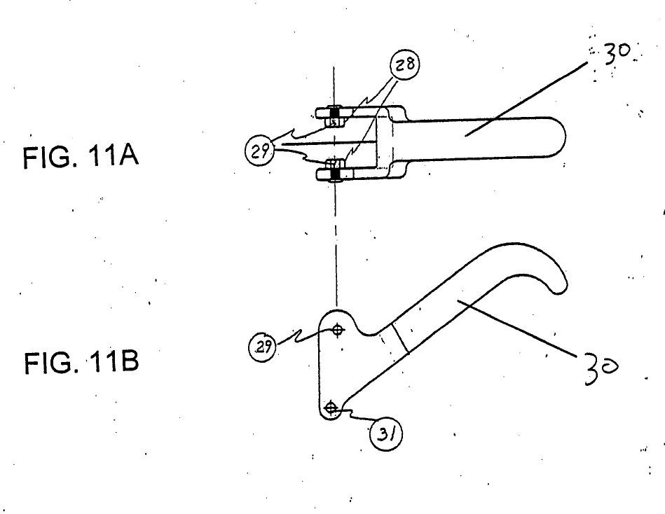

In addition, the drive lever control assembly 4 comprises a locking brake assembly 27 as can be seen in FIGS. 10A, 10B, 11A and 11B. The locking brake assembly 27 includes a set of locking rollers 28 positioned 180-degrees apart. The locking rollers 28 are mounted onto a guide pin 29 that protrudes from the brake control lever 30. The locking brake assembly 27 pivots around pivot point 31. When the locking brake assembly 27 is rotated towards the rubber handgrip 3, the locking rollers 28 wedge (become disposed) in between body 4A and lever arm 4B, locking the drive pads 5C of the driver arm assemblies, 5A and 5B, against the push wheel rim 23A.

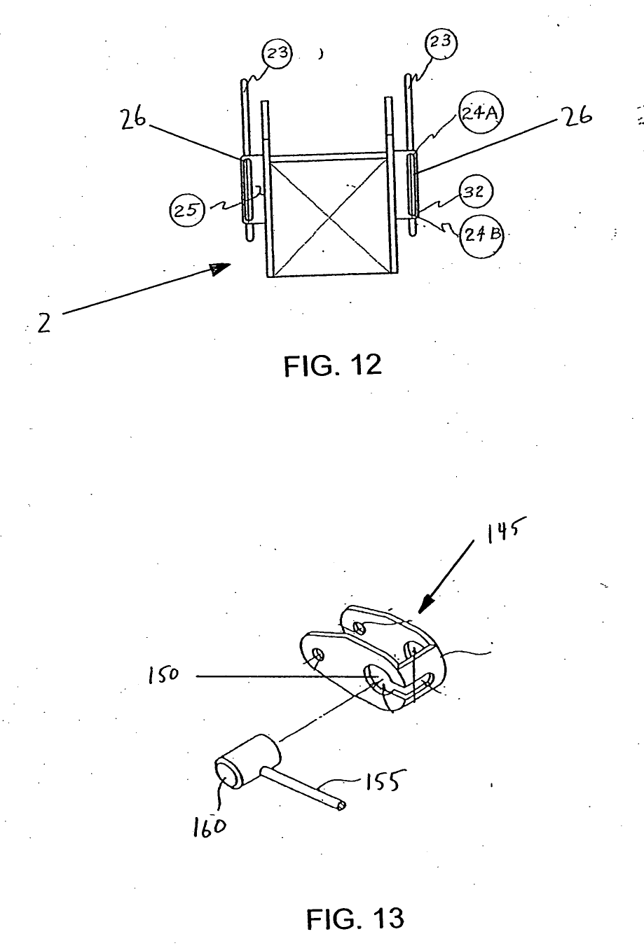

As depicted in FIG. 12, a fender 25 is attached to the wheelchair 2 above each push wheel 23. Each fender 25 includes a guide slot 26 in which the mobility device 1 travels or rides. At the front end of each guide slot 26 (the end towards the forward direction of the wheelchair 2) is a front directional limiter 24B. At the opposite or rear end of the guide slot 26 is a rear directional limiter 24A. Forward and backward movement of the mobility device 1 is limited by the directional limiters 24A and 24B. That is, the directional limiters 24A and 24B prevent the mobility device 1 from rotating 360-degrees. Instead, the mobility device 1 can only rotate or travel the distance of the guide slot 26. The guide slots 26 also prevent the mobility device 1 from moving side to side or laterally. This prevents the drive pads 5C from unintentionally binding or contacting the push wheel rims 23A when the instant device is not actuated by the user. In order to lock the push wheels 23, a fixing means such as but not limited to a locking pin 32 is included on the fender 25. The locking pin 32 is disposed 90-degrees to the guide slot 26 and prevents the mobility device 1 from rotating in either direction when the locking pin 32 is engaged with the mobility device 1. This allows the user to simultaneously engage the locking brake assembly 27 and the locking pin 32 to lock the push wheels 23 and prevent the wheelchair 2 from rolling.

Operation of a wheelchair 2 using the mobility device 1 will now be described in detail. In order to place the wheelchair 2 in motion, the user must rotate the push wheels 23. This is achieved in the following manner. Once seated in the wheelchair 2, a user grasps the rubber handgrips 3 of both the right and the left device 1 or lever and positions the device 1 in a desired location in the guide slot 26. As previously discussed, each device 1 has a drive lever control assembly 4 attached in the vicinity of the rubber handgrip. To rotate the push wheels 23 and hence propel the wheelchair 2, the user grasps the drive lever control assembly 4 and depresses the lever arm 4B towards the rubber grip 3. This action causes the lever arm 4B to pivot around pivot point 18. When the lever arm 4B is pivoted or actuated, a cable 21 that is attached to the cable restraining means 145 of the lever arm 4B is pulled in an upward direction.

As depicted in FIGS. 5A and 5B, the end of the cable 21 is connected to a junction connector 22. Junction connector 22 joins cable 21 to driver assembly cable 17 forming a “T” shape configuration. When cable 21 travels in an upward direction (a direction away from the push wheel 23), the junction connector 22 converts the vertical or upward pull to a substantially lateral pull (substantially perpendicular to the vertical pull of cable 21) in the driver assembly cable 17. This causes the driver assembly cable 17 to bow out in the center at the junction connector 22. Driver assembly cable 17 has cable ends 17A that are not connected to the junction connector 22. The driver assembly cable ends 17A connect to the upper portions 16 of the right and left driver arm assemblies 5A and 5B using any of the previously described cable restraining means. Therefore, when cable 21 is pulled upward and the vertical pull is converted by the junction connector 22 to a substantially lateral pull in driver assembly cable 17, the driver arm assemblies, 5A and 5B, are pulled towards each other causing the drive pads 5C to contact or engage the push wheel rim 23A. Friction between the drive pads 5C and the push wheel rim 23A fixes the mobility device 1 in relation to the push wheel 23 allowing the user to rotate the push wheel 23 by moving the mobility device 1 forwards or backwards in the guide slot 26. When pressure is released from the lever arm 4B, a spring or resilient member urges the driver arm assemblies, 5A and 5B, to move away from the push wheel rim 23A, back to their home positions, allowing the push wheel 23 and the mobility device 1 to again rotate freely or independently of one another. The mobility device 1 can now move independently of the push wheel 23 allowing the user to return the device to its original position in order to begin another cycle.

To propel the wheelchair 2 forward, a user positions both the left and the right mobility devices 1 towards the rear of the guide slots 26 without applying pressure to the lever arm 4B. Next, the user applies pressure to both the right and the left lever arms 4B in order to engage the drive pads 5C with the push wheel rim 23A. Once the drive pads 5C are moved into contact (engaged) with the push wheel rims 23A resulting in the mobility device 1 and the push wheels 23 being fixed in relation to one another, the user pushes both the left and the right mobility device 1 forward causing the push wheels 23 to rotate forward.

Once the user is finished pushing both devices 1 forward, the user releases pressure from the lever arms 4B and pulls the devices 1 back to their starting position and repeats the process for the desired distance. To propel the wheelchair 2 in reverse, a user positions both the left and the right mobility devices 1 towards the front of the guide slots 26 without applying pressure to the lever arm 4B. Next, the user applies pressure to both the right and the left lever arms 4B to move the drive pads 5C into contact with the push wheel rim 23A. Once the drive pads 5C are moved into contact with the push wheel rims 23A resulting in the mobility device 1 and the push wheels 23 being fixed in relation to one another, the user pulls both the left and the right mobility device 1 backward causing the push wheels 23 to rotate backward. Once the user is finished pulling the levers backward, the user releases pressure from the lever arms 4B and returns devices 1 back to their starting position and repeats the process for the desired distance.

Turning is achieved by only operating one mobility device 1 at a time or operating one device 1 over a longer distance or for a longer period of time than the other in the manner described above. That is, to turn left, only the right lever is actuated and pushed forward or the right lever is operated for a longer period of time. To turn right, the left lever is operated in the previously described manner. To turn in reverse, the same process is used but instead only one lever is actuated and pulled back at a time. Therefore, direction is entirely based upon which mobility device 1, the right or the left, is applying pressure or force to the push wheels 23.

Lastly, the mobility device 1 includes a braking system. As previously described and as depicted in FIGS. 10A, 100B, 1A and 11B, each lever comprises a locking brake assembly 27. When the brake control lever 30 is depressed towards the rubber handgrip 3, the locking rollers 28 wedge or become disposed in between the body 4A and the lever arm 4B and lock the drive pads 5C in contact with push wheel rim 23A. With the drive pads 5C of the mobility device 1 locked in a fixed position with the push wheels 23, the mobility device 1 itself can further be locked in place in the guide slot 26 using locking pin 32. This configuration prevents the wheelchair 2 from rolling. To release the braking system, the brake control lever 30 is again depressed towards the rubber grip 3 causing the locking rollers 28 to disengage from the body 4A and lever arm 4B resulting in force being removed from the drive pads 5C, once again allowing the push wheels 23 and the mobility devices 1 to move independently of one another.

Although a preferred embodiment of the present invention and modifications thereof have been described in detail herein, it is to be understood that this invention is not limited to this precise embodiment, and that other modifications and variations may be effected by one skilled in the art without departing from the spirit and scope of the invention as defined by the appended claims.

What is claimed is:

1. A wheelchair mobility apparatus for use on one or more push wheels of a wheelchair, comprising:
a substantially fork shaped member that straddles the one or more push wheels, the member having a first portion, a second portion and an intermediate portion disposed between the first portion and the second portion;
wherein the first portion pivotally mounts the member to the wheelchair; and
wherein the second portion extends above an armrest of the wheelchair.

2. The wheelchair mobility apparatus of claim 1 further comprising:
a means for fixing the substantially fork shaped member in relation to the one or more push wheels, wherein when the substantially fork shaped member is fixed in relation to the one or more push wheels, motion is imparted to the wheelchair by a user pulling or pushing the second portion of the substantially fork shaped member; and
a means for actuating the fixing means.

3. The wheelchair mobility apparatus of claim 1, wherein the substantially fork shaped member has two full legs.

4. The wheelchair mobility apparatus of claim 1, wherein the substantially fork shaped member has one full leg and one leg portion.

5. The wheelchair mobility apparatus of claim 3, wherein the two full legs each have a connecting structure at a free end for connecting to the wheelchair.

6. The two full legs of claim 5, wherein the connecting structures are cylindrically shaped.

7. The two full legs of claim 6, wherein the cylindrically shaped structures comprise a set of bearings.

8. The wheelchair mobility apparatus of claim 4, wherein the one full leg has a connecting structure at a free end for connecting to the wheelchair.

9. The one full leg of claim 7, wherein the connecting structure is cylindrically shaped.

10. The one full leg of claim 9, wherein the cylindrically shaped structure comprises a set of bearings.

11. The substantially fork shaped member of claim 1, wherein the second portion comprises a shank for gripping.

12. The substantially fork shaped member of claim 11, wherein a rubber handgrip is disposed on the shank.

13. The fixing means of claim 2, comprising:
a first lever arm having a first portion, a second portion and a middle portion, wherein the first portion is pivotally mounted in cantilever relation to a first side of the substantially fork shaped member;
a second lever arm having a first portion, a second portion and a middle portion, wherein the first portion is pivotally mounted in cantilever relation to a second side of the substantially fork shaped member;
a first friction pad attached to the first lever assembly at approximately the middle portion; and
a second friction pad attached to the second lever assembly at approximately the middle portion.

14. The fixing means of claim 13, wherein the first and second lever arms are connected to a resilient member for urging the levers back to their home positions when a force is removed from the lever arms.

15. The fixing means of claim 13, wherein the first portion of the first and second lever arms is a bearing.

16. The fixing means of claim 13, wherein the first and second friction pads are substantially laterally adjustable with respect to the first and second lever assembly.

16. The fixing means of claim 13, wherein the first and second friction pads are fixedly attached to the first and second lever assembly.

17. The fixing means of claim 13, wherein the second portion of the first and second lever arms comprises a cable retaining means.

18. The fixing means of claim 17, wherein a first end of a first cable is attached to the cable retaining means of the first lever assembly and a second end of the first cable is attached to the cable restraining means of the second lever assembly.

19. The fixing means of claim 18, wherein an intermediate portion of the first cable is connected to a cable coupling means.

20. The fixing means of claim 19, wherein a second cable is connected to the cable coupling means and is disposed substantially 90-degrees to the first cable resulting in a “T” shaped configuration of the first and second cables.

21. The actuating means of claim 2 comprising:
a body having a cable passageway at a bottom portion, the body fixedly mounted to the second portion of the substantially fork shaped member;
a lever arm having a cable retaining means at a bottom end, the lever arm pivotally mounted to the body; and
a locking assembly.

22. The actuating means of claim 21, wherein a cable is disposed through the cable passageway and fixedly attached to the lever cable retaining means.

23. The actuating means of claim 21, wherein the lever arm is in the shape of a hand lever.

24. The actuating means of claim 21, wherein the locking assembly comprises:
a control lever having a guide pin protruding therefrom, the control lever pivotally attached to the lever body; and
locking rollers disposed 180 degrees apart from one another.

25. The locking assembly of claim 24, wherein the locking rollers are movably mounted on the guide pin.

26. The actuating means of claim 24, wherein the control lever is in the shape of a hand lever.

27. The wheelchair of claim 1, wherein disposed above the one or more push wheels is a mobility apparatus movement limiting member.

28. The wheelchair of claim 27, wherein mobility apparatus movement limiting member limits a rotation and a lateral movement of the mobility apparatus.

29. The wheelchair of claim 27, wherein the mobility apparatus movement limiting member further comprises a fixing means to lock the mobility device in position.

30. A method for propelling a wheelchair comprising the steps:
positioning a braking member relative to one or more push wheels of the wheelchair;
locking the braking member into a fixed position relative to the one or more push wheels;
displacing the braking member frontward or rearward relative to the wheelchair in order to rotate the one or more push wheels and propel the wheelchair in a desired direction; and
repeating the preceding steps over a desired distance of movement.
